(19) United States
(12) Patent Application Publication
(10) Pub. No.: US 2024/0183365 A1
(43) Pub. Date: Jun. 6, 2024

(54) Compressed Air Supply Device

(71) Applicant: KOGANEI CORPORATION, Tokyo (JP)

(72) Inventors: Akiyoshi HORIKAWA, Tokyo (JP); Yu TAKEBAYASHI, Tokyo (JP); Rikuta FUJII, Tokyo (JP)

(73) Assignee: KOGANEI CORPORATION, Tokyo (JP)

(21) Appl. No.: 18/409,932

(22) Filed: Jan. 11, 2024

Related U.S. Application Data
(63) Continuation of application No. PCT/JP2022/026849, filed on Jul. 6, 2022.

(30) Foreign Application Priority Data
Jul. 12, 2021 (JP) 2021-115297

(51) Int. Cl. F15B 11/068; F16L 37/46

(52) U.S. Cl. CPC F15B 11/068; F16L 37/46

(57) ABSTRACT

A compressed air supply device having a simple structure capable of supplying compressed air from an outside to pneumatic equipment incorporated into a moving device. This compressed air supply device includes: an air supply head provided with an opposite surface opposing to a connection surface; an air supply rod arranged in the air supply head so as to be reciprocable between a projecting position where a projecting surface protrudes from the opposite surface and a retraction position where the projecting surface is retracted from the projecting position; and an on-off valve blocking communication between a compressed air supply source and an air guide path when the projecting surface is away from the connection surface and causing the compressed air supply source and an air inflow path to communicate with each other via the air guide path when the connection surface abuts on the projecting surface.

### CROSS-REFERENCE TO RELATED APPLICATIONS

This is a continuing application, under 35 U.S.C. § 120, of copending international application No. PCT/JP2022/026849, filed Jul. 6, 2022, which designated the United States and was not published in English; this application also claims the priority, under 35 U.S.C. § 119, of Japan patent application No. 2021-115297, filed Jul. 12, 2021; the prior applications are herewith incorporated by reference in their entirety.

### STATEMENT REGARDING FEDERALLY SPONSORED RESEARCH OR DEVELOPMENT

Not Applicable

### FIELD OF THE INVENTION

The present systems, apparatuses, and methods lie in the field of air supply. The present disclosure relates to a compressed air supply device for supplying compressed air to pneumatic equipment incorporated in a moving device.

### BACKGROUND OF THE INVENTION

Self-propelled dollies (AGV) for transporting workpieces and processed objects in factories include types of providing: pneumatic actuators such as air hands for gripping the processed objects; and a pneumatic control device for controlling the pneumatic actuators. In addition, working robots that move the processed objects and that perform various types of work such as welding include types of providing the pneumatic actuators for driving the robot arms and air hands, and the pneumatic control device that controls the pneumatic control device. When using the pneumatic actuators and the pneumatic control device on the self-propelled dolly, it is necessary to provide the pneumatic equipment or mount an air tank to supply compressed air from outside. If an air tank is provided in the moving device such as a self-propelled dolly in which the pneumatic actuator and the pneumatic control device are incorporated, compressed air can be supplied to the pneumatic actuator and the pneumatic control device. When a remaining amount of compressed air in the air tank is low, compressed air is supplied into the air tank by the compressed air supply equipment. Meanwhile, in the moving device that does not have the air tank, the compressed air is directly supplied to the pneumatic actuator and the pneumatic control device by the compressed air supply device when the pneumatic actuator and the pneumatic control device are operated.

Japanese Utility Model Application Laid-open No. S63-97791 discloses a supply device for supplying electric energy and pneumatic energy to automatic guided vehicles in automobile production plants. The supply device is guided by guide rails and is movable along the automatic guided vehicle, and a connector of the supply device is provided with a synchronization bar and a guide hole. The connector of the automatic guided vehicle is provided with a synchronization hole into which the synchronization bar is inserted and a guide bar that is inserted into the guide hole. Further, the connector of the automatic guided vehicle is provided with a reception coupler for receiving air energy from a supply coupler of the supply device, and the reception coupler is inserted into the supply coupler when supplying air energy from the supply device to the automatic guided vehicle. The reception coupler is connected to an accumulator which is the pneumatic equipment mounted on the automatic guided vehicle.

In the supply device disclosed in Japanese Utility Model Application Laid-open No. S63-97791, in order to position the supply coupler and the reception coupler, the synchronization bar is inserted into the synchronization hole, and then the guide bar is inserted into the guide hole, thereby making a position mechanism complicated. Further, if the connector of the supply device is provided with the synchronization bar and the guide hole and the connector of the automatic guided vehicle is provided with the synchronization hole and the guide bar, the respective connectors are not avoided making larger.

Japanese Patent Application Laid-open No. 2015-211997 discloses a work system in which a traveling carriage mounted by the work robot is moved to a plurality of work stations by guidance of a magnetic tape. An attachment of the travelling carriage is provided with a male coupling to which air is supplied and a magnetic attraction type terminal connector as power receiving equipment. A slide box movably provided along the guide rail is provided with a female coupling for air supply and a magnetic attraction type terminal connector as power supply equipment. The male coupling is inserted into the female coupling by causing the slide box to approach toward the work carriage, and compressed air is supplied to the pneumatic actuators and the pneumatic control device of the work robot mounted on the work carriage.

In the work system disclosed in Japanese Patent Application Laid-open No. 2015-211997, the traveling robot pulls the slide box toward its own attachment, thereby connecting the female coupling and the male coupling to perform air supply and signal connection. Also when separating the female coupling and the male coupling, the traveling robot causes the slide box to secede from the attachment. In this work system, the male and female couplings are connected and separated by a robot operation guided by a magnetic tape(s). The self-propelled dolly without the robot cannot position the attachment and the slide box and detach the magnet to cause the slide box to secede. It is also conceivable to mount an air compressor on the self-propelled dolly, but weight of the air compressor increases and a storage battery of the self-propelled dolly is consumed.

### SUMMARY OF THE INVENTION

The present disclosure describes providing a compressed air supply device of a simple structure, which is capable of supplying compressed air from outside to the pneumatic equipment incorporated in the moving device without using storage battery energy of the moving device.

A compressed air supply device according to the present invention supplies compressed air to pneumatic equipment mounted on a moving device from an inlet of an air inflow path communicating with the pneumatic equipment, the compressed air supply device including: an air supply head, which provides an opposite surface opposing a connection surface providing the inlet, and attached to a support member; an air supply rod arranged in the air supply head so as to be reciprocable between a projecting position where a projecting surface protrudes from the opposite surface and a retraction position where the projecting surface retracts from the projecting position; an air guide path formed in the air supply rod and provided with an outlet on the projecting surface; and an on-off valve that blocks communication with a compressed air supply source and the air guide path when the projecting surface is away from the connection surface, and causes the compressed air supply source and an air inflow path to communicate with each other via the air guide path.

The air supply head supplying compressed air from the connection surface of the moving device has a cylinder body movably provided with an air supply rod, the cylinder body is provided with an opposite surface opposing the connection surface. When the air supply rod is moved toward the connection surface, an outlet of an air guide path formed in the air supply rod is positioned with respect to an inlet of the air inflow path. The compressed air can be supplied to the moving object by abutting on the air supply rod with respect to the connection surface of the moving object, so that the compressed air can be supplied to the moving object by a device with a simple structure.

A compressed air supply device according to the present invention supplies compressed air to pneumatic equipment mounted on a moving device from an inlet of an air inflow path communicating with the pneumatic equipment, the compressed air supply device including: an air supply head, which provides an opposite surface opposing a connection surface providing the inlet, and attached to a support member; an air supply rod arranged in the air supply head so as to be reciprocable between a projecting position where a projecting surface protrudes from the opposite surface and a retraction position where the projecting surface retracts from the projecting position; an air guide path formed in the air supply rod and provided with an outlet on the projecting surface; and an on-off valve that blocks communication with a compressed air supply source and the air guide path when the projecting surface is away from the connection surface, and causes the compressed air supply source and an air inflow path to communicate with each other via the air guide path.

The air supply head supplying compressed air from the connection surface of the moving device has a cylinder body movably provided with an air supply rod, the cylinder body is provided with an opposite surface opposing the connection surface. When the air supply rod is moved toward the connection surface, an outlet of an air guide path formed in the air supply rod is positioned with respect to an inlet of the air inflow path. The compressed air can be supplied to the moving object by abutting on the air supply rod with respect to the connection surface of the moving object, so that the compressed air can be supplied to the moving object by a device with a simple structure.

With the foregoing and other objects in view, there is provided, a compressed air supply device, which supplies compressed air to pneumatic equipment mounted on a moving device, from an inlet of an air inflow path communicating with the pneumatic equipment, the compressed air supply device comprising an air supply head which provides an opposite surface opposing a connection surface providing the inlet and is attached to a support member, an air supply rod arranged in the air supply head so as to be reciprocable between a projecting position where a projecting surface protrudes from the opposite surface and a retraction position where the projecting surface retracts from the projecting position, an air guide path formed in the air supply rod and provided with an outlet on the projecting surface, and an on-off valve that blocks communication with a compressed air supply source and the air guide path when the projecting surface is away from the connection surface, and causes the compressed air supply source and the air inflow path to communicate with each other via the air guide path when the connection surface is abutted against the projecting surface.

In accordance with another feature, the on-off valve is provided on the air supply rod, a spring member that applies a pressing force directed to the connection surface is provided on the air supply rod, and the on-off valve blocks the communication with the compressed air supply source and the air guide path when the air supply rod is at the projecting position, and causes the compressed air supply source and the air inflow path to communicate with each other via the air guide path when the connection surface is abutted against the projecting surface and the air supply rod is at the retraction position.

In accordance with a further feature, there is provided a projecting piston movably attached in a cylinder hole formed in the air supply head, wherein a hollow projecting rod into which the air supply rod is movably incorporated is provided in the projecting piston, a communication hole causing a spring chamber, which is formed in the projecting piston and accommodates the spring member, and a forward air pressure chamber, which is formed in the cylinder hole, to communicate with each other is formed in the projecting piston, and the air supply rod is driven toward the connection surface by the projecting piston.

In accordance with an added feature, there is provided an air supply piston movably attached in a cylinder hole formed in the air supply head and integrally provided with the air supply rod, wherein the on-off valve is provided in an air supply path connected to the air guide path of the air supply rod and the air supply piston drives the air supply rod toward the connection surface to apply a pressing force toward the connection surface to the air supply rod.

In accordance with a concomitant feature, an abutment sealing member is provided on at least one of the connection surface and the projecting surface.

### BRIEF DESCRIPTION OF THE DRAWINGS

FIG. 1 is a perspective view showing one example of a compressed air supply device suppling compressed air to a track traveling vehicle serving as a moving device and pneumatic equipment provided thereon;

FIG. 2A is a front view showing a state in which the track traveling vehicle approaches the compressed air supply device;

FIG. 2B is a front view showing a state in which the compressed air supply device contacts with the track traveling vehicle;

FIG. 3A is a cross-sectional view showing a state in which an air supply head of the compressed air supply device of one embodiment opposes the track traveling vehicle;

FIG. 3B is a cross-sectional view showing a state in which the air supply head of the compressed air supply device is abutted against the track traveling vehicle;

FIG. 4A is a cross-sectional view showing an air supply head of a compressed air supply device according to another embodiment;

FIG. 4B is a cross-sectional view showing a state of supplying compressed air from the air supply head shown in FIG. 4A to pneumatic equipment of the track traveling vehicle; and

FIG. 5 is a cross-sectional view showing an air supply head of the compressed air supply device according to another embodiment.

### DETAILED DESCRIPTION OF THE EMBODIMENTS

Hereinafter, embodiments of the present invention will be described in detail with reference to the drawings. In each embodiment shown in the drawings, the same reference numerals are given to members having commonality.

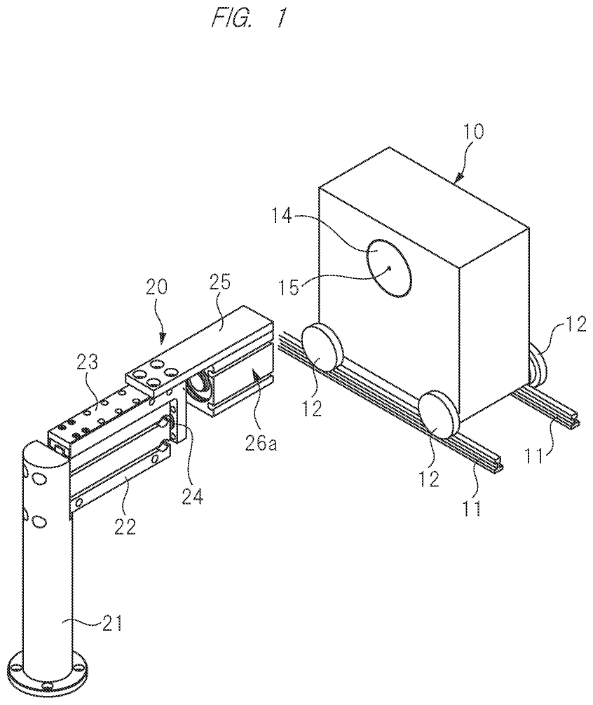

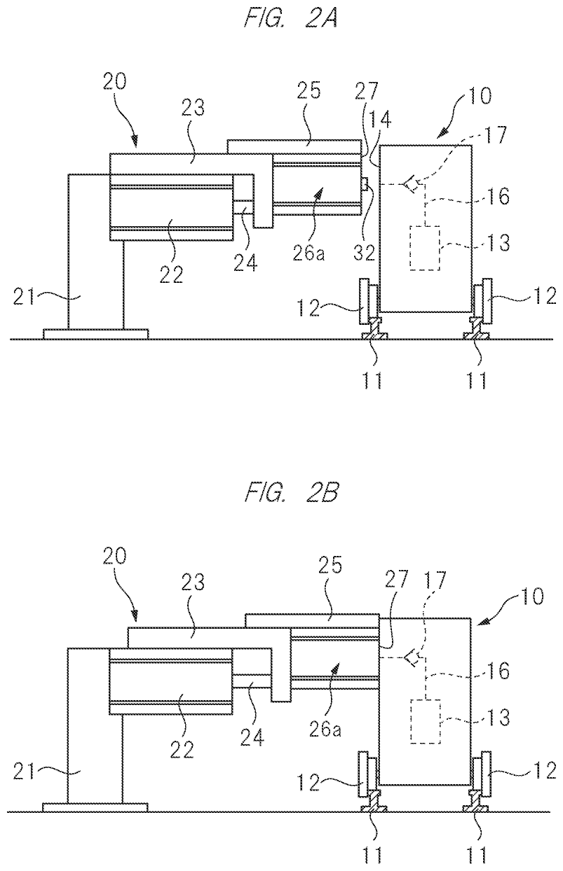

As shown in FIG. 1, a compressed air supply device 20 is applied to supply compressed air to pneumatic equipment provided in a track traveling vehicle 10 as a moving device, that is, a moving object. The track traveling vehicle 10 has wheels 12 that run on rails 11, and the wheels 12 are driven by an electric motor by a battery serving as a power source which is incorporated in the track traveling vehicle 10. As shown in FIGS. 2A and 2B, an air tank 13 as pneumatic equipment is provided in the track traveling vehicle 10, and a pneumatic actuator using, as a drive source, compressed air injected into the air tank 13 and a pneumatic control device for controlling the pneumatic actuator are provided on the track traveling vehicle 10 as another pneumatic equipment. The pneumatic actuator is a cylinder for driving a chuck or a hand that grips processed objects, a vacuum cup for sucking and holding the processed objects, and the like. The pneumatic control device is an on-off valve, a channel switching valve, and the like. However, the pneumatic actuator and the pneumatic control device are omitted from the drawing.

An inlet 15 is provided in a connection surface 14 on a side surface of the track traveling vehicle 10. As shown in FIGS. 2A and 2B, the inlet 15 communicates with an air tank 13 as a pneumatic device via the air inflow path 16 provided in the track traveling vehicle 10. A check valve 17 is provided in the air inflow path 16. The check valve 17 allows the compressed air to flow from the inlet 15 toward the air tank 13, and blocks a flow in an opposite direction.

The compressed air supply device 20 has a pneumatic cylinder 22 attached to a support member 21. A linear guide 23 is movably mounted on the pneumatic cylinder 22, and the linear guide 23 is connected to a rod 24 of the pneumatic cylinder 22. A support plate 25 is attached to the linear guide 23, and an air supply head 26a a is attached to the support plate 25. The air supply head 26a can approach toward and separate from the track traveling vehicle 10 by the pneumatic cylinder 22.

The air supply head 26a is formed by the pneumatic cylinder, and an end surface on a tip side is a flat opposite surface 27 opposing the connection surface 14 of the track traveling car 10. The track traveling vehicle 10 is accurately stopped at a predetermined position on the rail 11 by a travel control device so that the inlet 15 faces an air outlet provided in the air supply head 26a. Therefore, as shown in FIG. 2A, under the condition that the track traveling vehicle 10 is stopped at the air supply position by the air supply head 26a, if the pneumatic cylinder 22 is driven and the air supply head 26a is moved toward the track traveling vehicle 10, the air outlet of the air supply head 26a can be caused to communicate with the inlet 15.

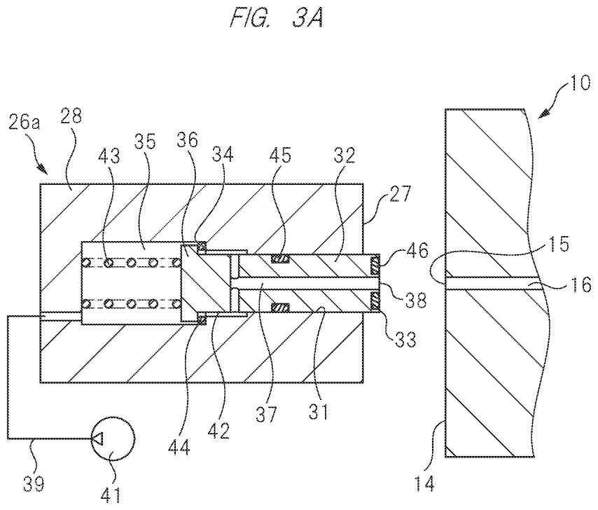

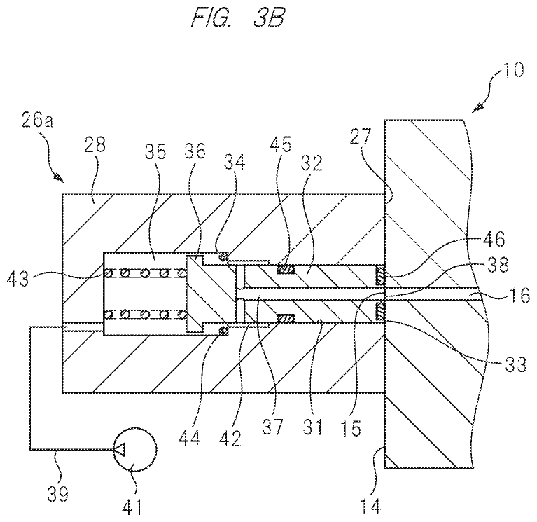

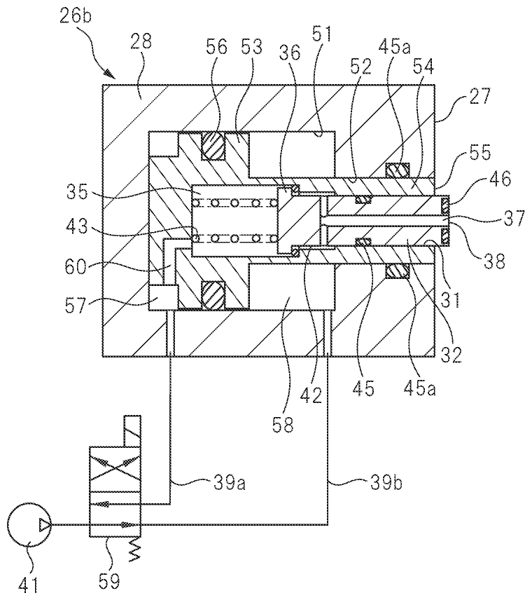

As shown in FIGS. 3A and 3B, the air supply head 26a has a cylinder body 28, a guide hole 31 opening to the opposite surface 27 is formed in the cylinder body 28, and an air supply rod 32 is attached to the guide hole 31 reciprocably in an axial direction. As shown in FIG. 3A, the air supply rod 32 moves between a projecting position where a tip surface of the air supply rod 32, that is, a projecting surface 33 protrudes from the opposite surface 27 and a retraction position where the projection surface 33 is retracted from this projecting position. A spring chamber 35 communicating with the guide hole 31 via a radial step surface 34 is formed in the cylinder body 28, and an inner diameter of the spring chamber 35 is larger than an inner diameter of the guide hole 31. An on-off valve 36 is formed by a large-diameter portion provided at a back end portion of the air supply rod 32, and the on-off valve 36 moves in the spring chamber 35 while opening and closing.

An air guide path 37 is formed in the air supply rod 32 to extend in the axial direction, and an outlet 38 of the air guide path 37 is formed in the projecting surface 33. The spring chamber 35 is connected to a compressed air supply source 41 by the air supply path 39, and compressed air is supplied to the spring chamber 35. A communication path 42 is formed between a base end portion of the air supply rod 32 and the cylinder body 28, and the communication path 42 communicates with the spring chamber 35 and the air guide path 37.

A compression coil spring 43 as a spring member is accommodated in the spring chamber 35, a tip of the compression coil spring 43 abuts on an end surface of the on-off valve 36, that is, a back end surface of the air supply rod 32, and a back end of the compression coil spring 43 abuts on a bottom wall of the cylinder body 28. The compression coil spring 43 applies a spring force to the air supply rod 32 in a direction in which the projecting surface 33 protrudes from the opposite surface 27. An on-off valve sealing member 44 is arranged between the on-off valve 36 and the step surface 34, and the compression coil spring 43 presses the on-off valve 36 against the step surface 34 via the on-off valve sealing member 44, and the communication with the spring chamber 35 and the air guide path 37 is blocked. At this time, the projecting surface 33 of the air supply rod 32 protrudes from the opposite surface 27 as shown in FIG. 3A. Meanwhile, when the projecting surface 33 is pressed by the connection surface 14 of the track traveling vehicle 10, as shown in FIG. 3B, the on-off valve 36 moves backward against the spring force and the spring chamber 35 and the air guide path 37 communicate with each other via the communication path 42 by opening the communication path.

A sealing member 45 provided on an outer peripheral portion of the air supply rod 32 seals a region between an outer peripheral surface of the air supply rod 32 and an inner peripheral surface of the guide hole 31. A region between the projecting surface 33 of the air supply rod 32 and the connection surface 14 is sealed by an abutment sealing member 46 provided at the tip portion of the air supply rod 32. Therefore, as shown in FIG. 3B, when the projecting surface 33 of the air supply rod 32 is abutted on the connection surface 14 and moves backward, the spring chamber 35 and the air guide path 37 become a state of communicating with each other via the communication path 42. At the same time, the abutment sealing member 46 seals the region between the projecting surface 33 and the connection surface 14, and the compressed air supplied from the compressed air supply source 41 is supplied to the air tank 13 as pneumatic equipment via the air inflow path.

Thus, when the air supply rod 32 is in the projecting position, the on-off valve 36 blocks the communication with the compressed air supply source 41 and the air guide path 37, and when the connection surface 14 is abutted on the projecting surface 33 and the air supply rod 32 reaches a retraction position, the compressed air supply source 41 and the air inflow passage 16 are caused to communicate with each other via the air guide path 37.

In the compressed air supply device 20 with the air supply head 26a, the track traveling vehicle 10 approaches the air supply head 26a and is stopped as shown in FIG. 2A. Consequently, a stop position is set so that the inlet 15 of the track traveling vehicle 10 is coaxial with the outlet 38 of the air supply head 26a. Under this condition, the linear guide 23 is driven by the pneumatic cylinder 22 and the air supply head 26a is driven forward toward the connection surface 14 of the track traveling vehicle 10, and the projecting surface 33 contacts with the connection surface 14.

FIGS. 2B and 3B each show a state in which the opposite surface 27 of the air supply head 26a abut on the connection surface 14 of the track traveling car 10, and the air supply rod 32 moves backward with respect to the cylinder body 28 and, thereby, the on-off valve 36 opens the communication path 42. Consequently, the compressed air discharged from the compressed air supply source 41 flows from the air guide path 37 into the air inflow path 16, and is supplied to the air tank 13 as receiving equipment provided in the track traveling vehicle 10. At this time, the spring force of the compression coil spring 43 is applied to the air supply rod 32 as a pressing force directed toward the connection surface 14, so that the abutment sealing member 46 adheres tightly to the connection surface 14, and a leakage of compressed air from between the connection surface 14 and the projecting surface 33 are prevented.

In this manner, the compressed air supply device 20 having a simple structure with the on-off valve 36 is formed by the air supply head 26a which is configured from the pneumatic cylinder provided with the air supply rod 32. The compression coil spring 43 that opens and closes the on-off valve 36 can apply a pressing force for pressing the projecting surface 33 against the connection surface 14.

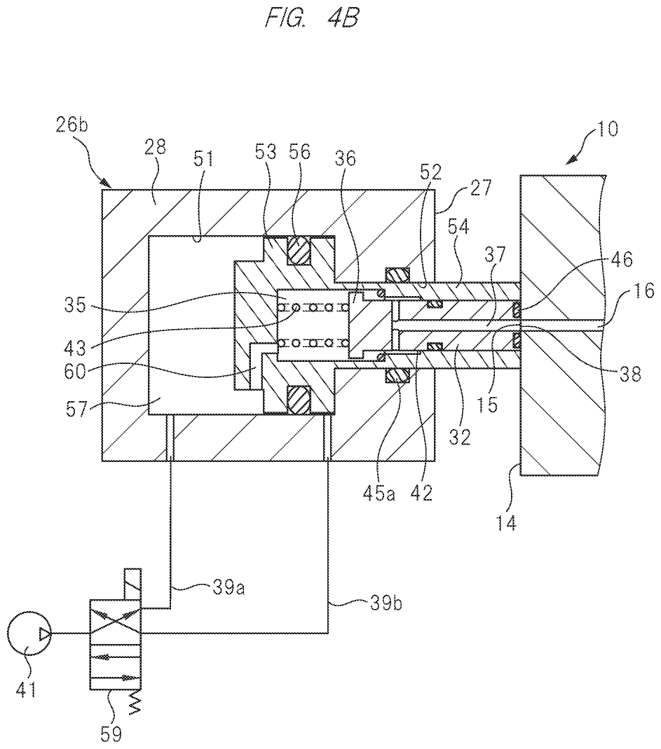

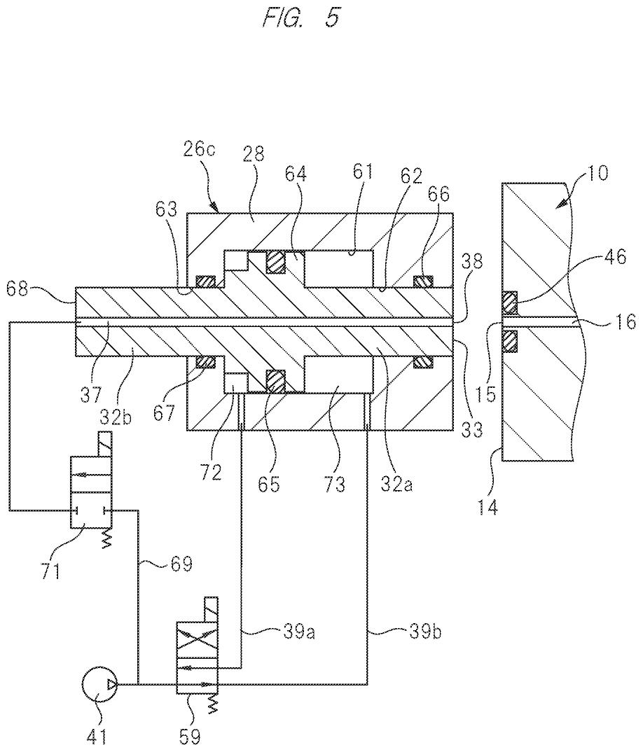

FIGS. 4A and 4B are cross-sectional views each showing an air supply head 26b of a compressed air supply device 20 according to another embodiment. In these figures, members having commonality with the members configuring the above-mentioned air supply head 26a are given the same reference numerals.

A cylinder hole 51 is formed in the cylinder body 28, a small-diameter guide hole 52 communicating with the cylinder hole 51 is formed in the cylinder body 28, and the guide hole 52 opens to the opposite surface 27. A projecting piston 53 is reciprocally attached to the cylinder hole 51, and a hollow projecting rod 54 provided in the projecting piston 53 is slidably inserted into the guide hole 52. FIG. 4A shows a state in which the projecting piston 53 has moved to a retraction limit position and, at this time, a tip surface 55 of the projecting rod 54 and the opposite surface 27 become substantially flush with each other. Meanwhile, FIG. 4B shows a state in which the projecting piston 53 has moved forward, and the projecting piston 53 causes the air supply rod 32 to abut on the connection surface 14.

A sealing member 56 contacting with the cylinder hole 51 is provided in the projecting piston 53. A forward air pressure chamber 57 and a backward air pressure chamber 58 are formed by the projecting piston 53 provided in the cylinder hole 51. A forward air supply path 39a is connected to the forward air pressure chamber 57, and a backward air supply path 39b is connected to the backward air pressure chamber 58. A channel switching valve 59 is provided between both air supply paths 39a and 39b and the compressed air supply source 41. When the compressed air from the compressed air supply source 41 is supplied to the retraction air pressure chamber 58 via the channel switching valve 59, the projecting piston 53 reaches the retraction limit position as shown in FIG. 4A. Meanwhile, when the compressed air from the compressed air supply source 41 is supplied to the forward air pressure chamber 57, the projecting piston 53 reaches a forward limit position as shown in FIG. 4B. Note that the sealing member 45a is provided on the inner peripheral surface of the guide hole 52, a region between the outer peripheral surface of the projecting rod 54 and the inner peripheral surface of the guide hole 52 is sealed.

The guide hole 31 and the spring chamber 35 are formed in the protruding rod 54, the air supply rod 32 is coaxially and movably incorporated in the guide hole 31, and the on-off valve 36 provided at a base end portion of the air supply rod 32 is arranged in the spring chamber 35. The spring chamber 35 communicates with the forward air pressure chamber 57 by the communication hole 60 formed in the projecting piston 53, and the spring chamber 35 communicates with the compressed air supply source 41 via the air pressure chamber 57.

As shown in FIG. 4A, under the conditions that the projecting piston 53 is set at the retraction limit position and the air supply rod 32 is driven by the spring force so that the projecting surface 33 protrudes from the opposite surface 27, as shown in FIG. 2A, as the track travelling vehicle 10 approaches the air supply head 26b and the inlet 15 of the air inflow path 16 is positioned so as to oppose the outlet 38 of the air guide path 37. Under this condition, when compressed air is supplied to the forward air pressure chamber 57, as shown in FIG. 4B, the projecting piston 53 moves forward and the projecting rod 54 is driven to protrude. Consequently, the tip surface 55 of the projecting rod 54 abuts on the connection surface 14 and the projecting surface 33 of the air supply rod 32 abuts on the connection surface 14.

When the projecting surface 33 abuts on the connection surface 14 and the air supply rod 32 moves backward, the on-off valve 36 allows the spring chamber 35 and the air guide path 37 to communicate with each other via the communication path 42. Consequently, the compressed air supplied from the compressed air supply source 41 to the forward air pressure chamber 57 is supplied to the air inflow path 16 via the communication hole 60, the spring chamber 35, the communication path 42, and the air guide path 37.

In this way, in the form in which the air supply rod 32 is incorporated in the projecting rod 54, a protruding operation and a pressing operation of the projecting surface 33 to the connection surface 14 can be performed by the projecting piston 53 instead of the rod 24 of the pneumatic cylinder 22. By arranging the air supply rod 32 coaxially with an inside of the projecting rod 54, the air supply head 26b can drive the air supply rod 32 to protrude by the air pressure from the compressed air supply source 41 and, at the same time, can supply compressed air to the pneumatic equipment in the track traveling vehicle 10. Therefore, downsizing of the compressed air supply device provided with the positioning mechanism for the projecting surface 33 can be achieved by a simple structure. However, it is also possible to drive both the rod 24 of the pneumatic cylinder 22 and the projecting piston 53 to apply the pressing force against the connection surface 14 to the projecting surface 33.

If the sealing member is further attached to the tip surface 55 of the projecting rod 54, air leakage from the connection surface 14 can be prevented together with the abutment sealing member 46 provided on the projecting surface 38 of the air supply rod 32.

FIG. 5 is a cross-sectional view showing an air supply head 26c of a compressed air supply device 20 according to still another embodiment.

The cylinder body 28 of the air supply head 26c is of a double-rod type, and the cylinder hole 61 is formed in the cylinder body 28. A small-diameter guide hole 62 communicating with the cylinder hole 61 is formed in a front end wall portion of the cylinder body 28, and a small-diameter guide hole 63 communicating with the cylinder hole 61 is formed in a back end wall portion of the cylinder body 28. The both guide holes 62, 63 and the cylinder hole 61 are coaxial with each other. The air supply piston 64 is reciprocally attached to the cylinder hole 61, and the air supply rod 32a slidably attached in the guide hole 62 is provided on a front surface side of the air supply piston 64, and the air supply rod 32b slidably attached in the guide hole 63 is provided on a back surface side of the air supply piston 64. The air supply piston 64 and the air supply rods 32a, 32b are integrally formed. A sealing member 65 that contacts with the cylinder hole 61 is provided on the air supply piston 64, and a sealing member 66 that contacts with the air supply rod 32a is provided on the cylinder body 28, and a sealing member 67 that contacts with the air supply rod 32b is provided on the cylinder body 28.

The end surface of the air supply rod 32a is the projecting surface 33, and the air guide path 37 penetrates between an end surface 68 and the projecting surface 33 of the air supply rod 32b. An air supply path 69 connected to the compressed air supply source 41 is connected to the air supply rod 32b, and an on-off valve 71 is provided in the air supply path 69. The on-off valve 71 switches between a state of opening the air supply path 69 and supplying, to the air guide path 37, the compressed air discharged from the compressed air supply source 41 and a state of blocking the air supply path 69. Therefore, the on-off valve 71 blocks the communication with the compressed air supply source 41 and the air guide path 37 when the projecting surface 33 is separated from the connection surface 14. Meanwhile, when the connection surface 14 abuts on the projecting surface 33, the on-off valve 71 causes the compressed air supply source 41 and the air inflow path 16 to communicate with each other via the air guide path 37 in order to supply compressed air to the pneumatic equipment of the track traveling vehicle 10.

A forward air pressure chamber 72 and a backward air pressure chamber 73 are formed by the air supply piston 64 provided in the cylinder hole 61. The forward air supply path 39a is connected to the forward air pressure chamber 72, and the backward air supply path 39b is connected to the backward air pressure chamber 73. A channel switching valve 59 is provided between both the both air supply paths 39a, 39b and the compressed air supply source 41. When the compressed air from the compressed air supply source 41 is supplied to the backward air pressure chamber 73 via the channel switching valve 59, as shown in FIG. 5, the air supply piston 64 reaches the backward limit position. Meanwhile, when the compressed air from the compressed air supply source 41 is supplied to the forward air pressure chamber 72, the air supply piston 64 reaches the forward limit position and the projecting surface 33 of the air supply rod 32a protrudes in a front direction of the opposite surface 27 from a position shown in FIG. 5.

Thus, in a mode in which the air supply rods 32a and 32b are provided on the air supply piston 64, the projecting operation of the projecting surface 33 to the connection surface 14 can be performed by the air supply piston 64 instead of the rod 24 of the pneumatic cylinder 22. The air supply head 26c has such a simple structure so as to arrange the double-rod type air supply piston 64 in the cylinder body 28, thereby achieving the downsizing of the compressed air supply device provided with the positioning mechanism for the projecting surface 33. The compressed air can be supplied to the pneumatic equipment in the track traveling vehicle 10 by the air pressure from the compressed air supply source 41 and, at the same time, the pressing force directed to the connection surface 14 can be applied to the air supply rod 32a by driving the air supply rod 32 to protrude. The projection surface 33 can also be pressed against the connection surface 14 by driving both the rod 24 of the pneumatic cylinder 22 and the projection pin 64.

The abutment sealing member 46 for sealing the region between the connection surface 14 and the projecting surface 33 is provided on the connection surface 14 unlike the above-described embodiment. That is, the abutment sealing member 46 is provided in an annular groove formed in the connection surface 14. Also in each of the air supply heads 26a, 26b, 26c in the above-described embodiment, the abutment sealing member 46 may be provided on the connection surface 14.

The present invention is not limited to the above-described embodiments, and can variously be modified without departing from the scope of the present invention. The compressed air supply device 20 causes the inlet 15 of the track traveling vehicle 10 to move at the position of the outlet 38 of the air supply head and supplies compressed air to the pneumatic equipment of the track traveling vehicle 10. However, the present invention is not limited to the track traveling vehicle 10, and if the inlet 15 can be positioned at the position of the outlet 38 and as long as compressed air is supplied to a moving object in which equipment operated by air pressure is mounted, the present invention can be applied to anything. Further, air pressure equipment supplying compressed air may be not only the air y for supplying compressed air to the pneumatic actuator or the pneumatic control equipment but also air pressure equipment directly supplying compressed air to the air pressure equipment as the pneumatic actuator or pneumatic control equipment.

The compressed air supply device of the present invention can be used to supply compressed air to pneumatic equipment incorporated in a moving device.

What is claimed is:

1. A compressed air supply device, which supplies compressed air to pneumatic equipment mounted on a moving device, from an inlet of an air inflow path communicating with the pneumatic equipment, the compressed air supply device comprising:
an air supply head which provides an opposite surface opposing a connection surface providing the inlet and is attached to a support member;
an air supply rod arranged in the air supply head so as to be reciprocable between a projecting position where a projecting surface protrudes from the opposite surface and a retraction position where the projecting surface retracts from the projecting position;
an air guide path formed in the air supply rod and provided with an outlet on the projecting surface; and
an on-off valve that blocks communication with a compressed air supply source and the air guide path when the projecting surface is away from the connection surface, and causes the compressed air supply source and the air inflow path to communicate with each other via the air guide path when the connection surface is abutted against the projecting surface.

2. The compressed air supply device according to claim 1, wherein:
the on-off valve is provided on the air supply rod;
a spring member that applies a pressing force directed to the connection surface is provided on the air supply rod; and
the on-off valve blocks the communication with the compressed air supply source and the air guide path when the air supply rod is at the projecting position, and causes the compressed air supply source and the air inflow path to communicate with each other via the air guide path when the connection surface is abutted against the projecting surface and the air supply rod is at the retraction position.

3. The compressed air supply device according to claim 2, further comprising a projecting piston movably attached in a cylinder hole formed in the air supply head, wherein:
a hollow projecting rod into which the air supply rod is movably incorporated is provided in the projecting piston;
a communication hole causing a spring chamber, which is formed in the projecting piston and accommodates the spring member, and a forward air pressure chamber, which is formed in the cylinder hole, to communicate with each other is formed in the projecting piston; and
the air supply rod is driven toward the connection surface by the projecting piston.

4. The compressed air supply device according to claim 1, further comprising an air supply piston movably attached in a cylinder hole formed in the air supply head and integrally provided with the air supply rod, wherein:
the on-off valve is provided in an air supply path connected to the air guide path of the air supply rod; and
the air supply piston drives the air supply rod toward the connection surface to apply a pressing force toward the connection surface to the air supply rod.

5. The compressed air supply device according to claim 1, wherein an abutment sealing member is provided on at least one of the connection surface and the projecting surface.
